(19) United States
(12) Patent Application Publication
(10) Pub. No.: US 2026/0275806 A1
(43) Pub. Date: Sep. 17, 2026

(54) REMOTE CONTROL FOR A SOLAR PROTECTION INSTALLATION AND SOLAR PROTECTION INSTALLATION AS SUCH

(71) Applicant: SOMFY ACTIVITES SA, CLUSES (FR)

(72) Inventors: Héléna ROBERT, CLUSES (FR); Mathieu PREVOTEAU, CLUSES (FR); Thomas DESAGRE, CLUSES (FR)

(21) Appl. No.: 19/473,592

(22) PCT Filed: Apr. 16, 2024
(86) PCT No.: PCT/FR2024/050505

§ 371 Date: Oct. 8, 2025

(30) Foreign Application Priority Data
Apr. 17, 2023 (FR) FR23/03829

(51) Int. Cl. E06B 9/322; E06B 9/24; H01H 23/04; H01H 23/14; H01H 23/24

(52) U.S. Cl. CPC E06B 9/322; H01H 23/04; H01H 23/143; H01H 23/24; E06B 2009/2476; E06B 2009/3222

(57) ABSTRACT

A remote control unit intended to control a control unit of a solar protection installation and a corresponding solar protection installation, the remote control unit including a housing; at least two actuating devices mounted so as to tilt relative to the housing and each having an elongate shape along an elongation direction, the at least two actuating devices being disposed substantially parallel to each other, and also being offset from each other along a longitudinal axis extending substantially perpendicular to the elongation direction.

### TECHNICAL FIELD OF THE INVENTION

The present invention relates to a remote control unit intended to control a control unit of a solar protection installation, said remote control unit comprising:
a housing;
at least one electronic control circuit housed in the housing, and comprising at least two switching elements each likely to occupy an active state and an inactive state;
at least two actuating devices, where each actuating device is mounted so as to tilt relative to the housing and comprises:
   a control button configured to tilt about at least one tilt axis between a rest position and at least one actuating position;
   at least one return element tending to tilt the control button about said at least one tilt axis towards the rest position;
   at least one actuating member secured to tilt with the control button, said at least one actuating member cooperating with one of the switching elements of the at least one electronic control circuit, and being configured to actuate said one of the switching elements to place it in the active state or in the inactive state intended to control a control unit of a solar protection installation, in particular concerning the actuation of the control button of the actuating devices present on the remote control unit to selectively activate or not a corresponding function of the solar protection installation.

The invention also relates to a solar protection installation comprising such a remote control unit.

The present invention finds particular application in the field of home automation.

### STATE OF THE ART

It is known from the state of the art to use actuating devices to actuate switching elements of a manual remote control unit, such as for example switches disposed on an electronic control circuit.

Pressing a given pressing area of the actuating device allows actuating the switching element to switch it into an active state, which causes the implementation of the electrical function associated with this switching element. For example, such an electrical function may be the closing of an electrical circuit of which the switching element is an integral part.

Advantageously, the actuating device may comprise a return mechanism associated with the pressing area, and configured to provide a function of returning the pressing area to a rest position. Thus, the release of the pressing area allows the switching element to return to its inactive state, and this is the reason for the existence of the aforementioned return mechanism. To control simple electrical functions through a remote control unit, it is known to use actuating devices configured to tilt about a tilt axis. Documents WO2018/040672A1 and KR20-0161547 disclose in particular such devices used in different technological fields.

However, although these solutions are satisfactory in that they allow the control of the switching elements of a control system, they present in return a complexity of design and manufacturing, and also involve a high manufacturing cost.

This effect is increased tenfold in the case of controlling a solar protection installation with several mobile bars, also known as TDBU type (which is the acronym for “Top Down Bottom Up”) because such installations generally involve a remote control unit with multiple functions (to select and then actuate each bar of the installation) which are not always intuitive for the user. This makes the solution impractical and lacking in user-friendliness.

Thus, there is a need to provide a remote control unit that is both simple and inexpensive to produce, but also user-friendly, practical and intuitive in its use, particularly for controlling complex systems, for example TDBU type solar protection installations.

Remote control units are for example described in documents US2005/194243A1, JPS552015U, DE10359172A1 or U.S. Pat. No. 5,598,918A, but they are not intended to control a solar protection control unit.

### SUBJECT OF THE INVENTION

The present invention aims to propose a solution which responds to all or part of the aforementioned problems.

This aim can be achieved thanks to the implementation of a remote control unit intended to control a control unit of a solar protection installation, said remote control unit comprising:
a housing;
at least one electronic control circuit housed in the housing, and comprising at least two switching elements each likely to occupy an active state and an inactive state;
at least two actuating devices, where each actuating device is mounted so as to tilt relative to the housing and comprises:
   a control button configured to tilt about at least one tilt axis between a rest position and at least one actuating position;
   at least one return element tending to tilt the control button about said at least one tilt axis towards the rest position;
   at least one actuating member secured to tilt with the control button, said at least one actuating member cooperating with one of the switching elements of the at least one electronic control circuit, and being configured to actuate said one of the switching elements to place it in the active state or in the inactive state;
remote control unit in which, for at least one of the actuating devices, the at least one actuating position comprises a first actuating position and a distinct second actuating position;
wherein the at least one switching element of the electronic control circuit comprises a first switching element and a second switching element, and in which the at least one actuating member of one of the actuating devices comprises a first actuating member configured to actuate the first switching element when the control button occupies the first actuating position, and a second actuating member configured to actuate the second switching element when the control button occupies the second actuating position; and
said at least two actuating devices each having an elongated shape along an elongation direction, and being disposed substantially parallel to each other, said at least two actuating devices being further offset from each other along a longitudinal axis extending substantially perpendicular to the elongation direction.

The provisions described above make it possible to propose a remote control unit capable of piloting an installation controlled by a control unit, for example a solar protection installation comprising a control unit. The presence of two actuating devices makes it possible to increase the number of commands that can be transmitted by the remote control unit when a user actuates one of the two actuating devices. Furthermore, and advantageously, if the remote control unit is configured to control a solar protection installation comprising two bars actuated selectively or simultaneously by an electromechanical actuator, the positioning of the two actuating devices on the remote control unit can correspond to the spatial distribution of the two bars. In this way, the implementation of the displacement of the two bars is very intuitive.

The provisions described above also make it possible to propose a remote control unit in which each actuating device is adapted to actuate a switching element when the control button is actuated by the user and to return to the rest position when the control button is not actuated. As a result, the remote control unit is practical and intuitive to use. In addition, the two devices can be activated simultaneously. Alternatively, a particular control function can allow the actuation of one of the devices to cause the two bars to move.

Moreover, the remote control unit is therefore able to control two different actions through a single control button.

The remote control unit may further have at least one of the following characteristics, taken alone or in combination.

According to one embodiment, the at least one of the actuating members is configured to place the switching element with which it cooperates in the active state when the control button is switched into the actuating position.

According to one embodiment, the at least one of the actuating members is configured to place the switching element with which it cooperates in the inactive state when the control button is switched to the rest position.

According to one embodiment, the rest position that each control button can occupy is a stable position. In other words, it is a position naturally occupied by the control button (under the effect of the at least one return element) when no external manual force is applied to the control button. Consequently, the actuating position is only likely to be occupied at the moment when this external manual force is applied.

It is understood that the remote control unit may comprise more than two actuating devices of the same type or of a type different from that of the two actuating devices.

According to one embodiment, the tilt axes of the control buttons are substantially parallel.

According to one embodiment, the elongation direction is substantially parallel to at least one of the tilt axes.

According to one embodiment, the housing extends along the longitudinal axis. The longitudinal axis therefore becomes a main direction along which the remote control unit is generally elongated, in the sense that it has a dimension corresponding to a length of the housing measured along the longitudinal axis which is significantly greater than the two other dimensions corresponding to a width and a thickness of the housing respectively measured along the two other axes of an orthonormal reference system associated with the remote control unit.

According to one embodiment, the housing comprises a grip portion and a control portion distinct from each other, said actuating devices being mounted so as to tilt relative to the housing in the control portion.

Thus, the user of the remote control unit can hold the remote control unit in his hand at the grip portion while simply actuating the actuating devices, for example with his thumb at the control portion.

According to one embodiment, the at least one of said actuating devices is pivotally mounted relative to the housing, about the corresponding tilt axis.

This allows the switching element to be actuated with a simple pure rotational movement (without translation) about the tilt axis, thus avoiding the complex kinematic of the tilting of the control button.

According to one embodiment, said at least one return element is integrally formed with the control button.

In other words, said at least one return element and the control button are integrally formed in a single and same one-piece part.

Advantageously, the production of an actuating device in which the return element is integrally formed with the control button makes it possible to simplify the manufacture of the actuating device, which reduces the production costs of such an actuating device. It is therefore understood that the control button and the return element form, in this embodiment, a single integral part.

According to one embodiment, the actuating member is integrally formed with the control button.

According to one embodiment, the actuating device is a single integral part.

In this way, it is possible to produce the actuating device, without requiring a mechanical assembly adjusted between the return element and the control button. The obtained actuating device is thus robust, efficient and economical. Furthermore, it is thus possible to limit the number of parts to be used when assembling the actuating device.

According to one embodiment, the actuating device comprises a polymer material, for example polyoxymethylene.

According to one embodiment, the actuating device is made of a polymer material, for example polyoxymethylene.

Advantageously, the use of a polymer material makes it possible to produce the actuating device with low-cost manufacturing methods. In addition, polyoxymethylene is particularly suitable as a material forming the return element and to withstand friction, particularly induced during the displacement of the actuating device.

According to one embodiment, for at least one of the actuating devices, the at least one return element comprises a first return element tending, when an actuating device has been manually actuated in a first direction between the rest position and the first actuating position, to tilt the control button about the at least one tilt axis from the first actuating position to the rest position in a reverse tilt direction, and a second return element tending, when an actuating device has been manually actuated in a second direction between the rest position and the second actuating position, to tilt the control button about the at least one tilt axis from the second actuating position to the rest position in a reverse tilt direction.

In other words, when an actuating device has been manually actuated in a first direction between the rest position and the first actuating position, the first return element exerts on the control button a first return torque urging the control button to pivot about the at least one tilt axis in the reverse tilt direction going from the first actuating position to the rest position, and when an actuating device has been manually actuated in a second direction between the rest position and the second actuating position, the second return element exerts on the control button a second return torque urging the control button to pivot about the at least one tilt axis in a reverse tilt direction going from the second actuating position to the rest position.

In this way it is possible to obtain an actuating device in which the control button is able to vary between two actuating positions, for example to actuate two separate switching elements.

According to one embodiment, a direction of tilting of the control button about the at least one tilt axis from the first actuating position to the rest position is opposite to the direction of tilting of the control button about the at least one tilt axis from the second actuating position to the rest position.

In this way, the control button is able to actuate one or several switching elements in a back-and-forth movement, which makes the actuating device ergonomic, simple, practical and user-friendly.

According to one embodiment, at least one of the return elements is an elastic return blade.

Thus, the manufacture of the at least one return element is simplified and economical, while being reliable and efficient.

According to one embodiment, said elastic return blade comprises at least one curved portion.

According to one embodiment, the elongated shape of at least one of the control buttons extends substantially parallel to the tilt axis. This provides comfort of use by offering a large width of manual pulling and/or pushing on the concerned control button. In addition, this makes the solution intuitive and ergonomic in the particular case where the remote control unit ensures the piloting of a solar protection installation including a shading device with two individually movable bars, because the general elongated shape of the control button is representative of the elongated shape of the bar whose displacement is precisely controlled by the actuation of said control button.

According to one embodiment, the at least one of the control buttons has a generally rectilinear shape.

According to one embodiment, the control buttons of said at least two actuating devices have a substantially identical shape.

Thus, the actuation of the control button by a user's finger is facilitated. Indeed, the shape of the control button allows the displacement of the control button transversely to its elongation direction.

According to one embodiment, at least two actuating devices are disposed such that the longitudinal axis passes through the center of their respective control buttons. In other words, the control buttons are parallel and have their geometric centers aligned along the longitudinal axis. This makes the actuation of the control buttons more predictable and intuitive for the user of the remote control unit.

According to one embodiment, the at least one of the actuating members comprises a pressing stud projecting relative to the control button, said pressing stud having a pressing surface configured to come into pressing contact, at least in the actuating position of the control button, with the switching element.

This makes it possible to form an actuating member that is sufficiently precise and robust to actuate the switching element.

According to one embodiment, the at least one actuating member comprises a first actuating member configured to actuate a first switching element and a second actuating member configured to actuate a second switching element.

According to one embodiment, the at least one of the actuating devices comprises a guide element secured to the control button and configured to allow the control button to tilt about the at least one tilt axis.

According to one embodiment, the guide element extends along an axis parallel to or coincident with the tilt axis.

According to one embodiment, the actuating member projects from the guide element. According to one embodiment, the guide element is configured to pivot about the tilt axis when the control button is tilted between the at least one actuating position and the rest position.

According to one embodiment, the second actuating member is disposed on the side opposite the first actuating member relative to the control button, or relative to the guide element.

In this way, the actuating device is configured to actuate two distinct switching elements when the control button is switched to each actuating position. It is thus possible to actuate two switching elements simply with a single control button. In particular, actuation in the first direction of the first control button makes it possible to control a movement of the upper bar in a first direction of displacement and actuation in the second direction of the first control button makes it possible to control a movement of the upper bar in a second direction of displacement. Similarly, actuation in the first direction of the second control button makes it possible to control a movement of the lower bar in a first direction of displacement and actuation in the second direction of the second control button makes it possible to control a movement of the lower bar in a second direction of displacement.

According to one embodiment, the housing comprises a recess configured to receive at least one projecting portion of the guide element, so as to allow, directly or indirectly, the actuating device to be mounted so as to tilt relative to the housing.

In this way, it is possible to make the connection between the actuating device and the housing more robust.

The aim of the invention can also be achieved thanks to the implementation of a solar protection installation comprising:
a remote control unit as described above, comprising a first and a second actuating device;
a shading device comprising at least:
   an upper bar;
   a lower bar; and
a screen disposed between the upper bar and the lower bar; a motorized drive device configured to deploy and retract the screen, and comprising at least one electromechanical actuator configured to move the upper bar and the lower bar, the motorized drive device further comprising a control unit configured to control the displacement of the upper bar depending on the active or inactive state of the at least one of the switching elements associated with the first actuating device, and configured to control the displacement of the lower bar depending on the active or inactive state of the at least one of the switching elements associated with the second actuating device.

The provisions described above make it possible to propose a solar protection installation in which the actuation of the two bars by the two electromechanical actuators is made intuitive by the positioning of the two actuating devices on the remote control unit which is representative of the actual spatial distribution of the two bars.

According to one embodiment, the remote control unit further comprises an independent button, activating an additional switching element.

According to one embodiment, the control unit is configured to control the simultaneous displacement of the lower bar and the upper bar in the same direction of displacement when the additional switching element is activated by the independent button. For example, such simultaneous displacement of the lower bar and the upper bar is performed for a predetermined period.

According to one embodiment, the independent button is kept illuminated when it activates the additional switching element, and in particular during said predetermined period.

### BRIEF DESCRIPTION OF THE DRAWINGS

Other aspects, aims, advantages and characteristics of the invention will appear better on reading the following detailed description of preferred embodiments thereof, given as a non-limiting example, and made with reference to the appended drawings in which:

FIG. 1 is a schematic view of a solar protection installation according to a particular embodiment of the invention.

FIG. 2 is a schematic perspective view of a remote control unit according to a particular embodiment of the invention.

FIG. 3 is a schematic perspective view of an actuating device according to a particular embodiment of the invention.

FIG. 4 is a schematic perspective view of an actuating device according to a particular embodiment of the invention, the control button of which is in the rest position.

FIG. 5 is a schematic perspective view of the actuating device of FIG. 4, the control button of which is in the first actuating position.

FIG. 6 is a schematic perspective view of the actuating device of FIG. 4, the control button of which is in the second actuating position.

### DETAILED DESCRIPTION

In the figures and in the remainder of the description, the same references represent identical or similar elements. Furthermore, the different elements are not represented to scale so as to favor the clarity of the figures. Furthermore, the different embodiments and variants are not mutually exclusive and can be combined with each other.

In the present document, the terms “substantially parallel” mean “parallel or parallel within 10 degrees”. The terms “substantially perpendicular” mean “perpendicular or perpendicular within 10 degrees”.

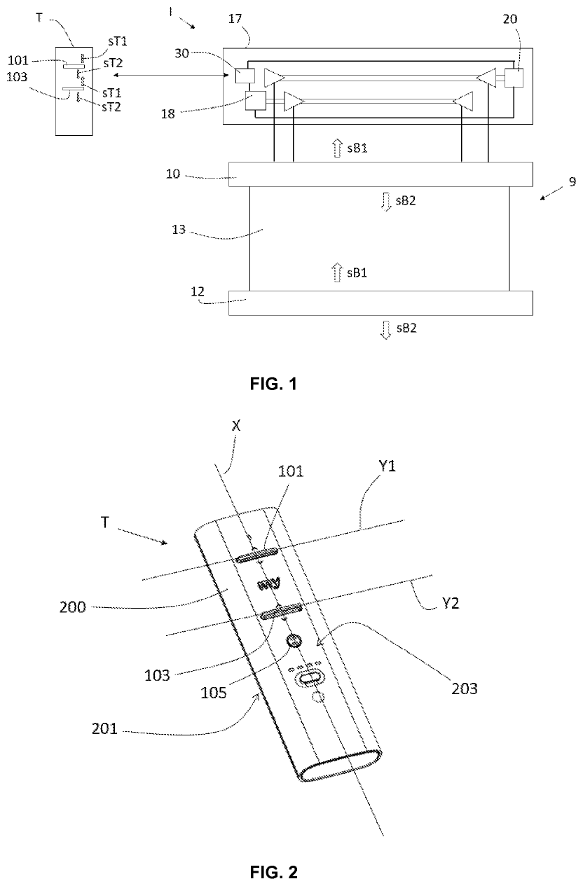

As illustrated in FIGS. 1 and 2, the invention relates to a remote control unit denoted “T” which is intended to control a control unit 30 of a solar protection installation denoted “I”, in particular by means of wireless commands, in particular radio commands.

FIG. 1 shows in particular a particular embodiment of a solar protection installation I according to the invention. Such a solar protection installation I is generally positioned in a building, and in front of an opening, such as a window or a door.

As can be seen in FIG. 1, the solar protection installation I comprises a shading device 9 comprising at least one upper bar 10, a lower bar 12, and a screen 13 disposed between the upper bar 10 and the lower bar 12, and configured to shade or not shade all or part of the opening. For example, the screen 13 can be formed from a pleated or honeycombed fabric. The screen 13 is generally disposed to be deployed between the two bars 10, 12. The upper bar 10 can for example be linked to an upper edge of the screen 13, and the lower bar 12 can be linked to a lower edge of the screen 13, parallel to the upper edge of the screen 13. In this way, the upper bar 10 is parallel to the lower bar 12. Depending on the relative position of the upper and lower bars 10, 12, the screen 13 is more or less deployed.

The solar protection installation I further comprises a motorized drive device 17 configured to deploy and retract the screen 13. This motorized drive device comprises at least one electromechanical actuator 18, 20 configured to move the upper bar 10 and the lower bar 12, and a control unit 30. In the non-limiting variant represented in FIG. 1, the at least one electromechanical actuator 18, 20 comprises a first electromechanical actuator 18 configured to move the upper bar 10, and a second electromechanical actuator 20 configured to move the lower bar 12. The drive device 17 may be configured to vertically drive the upper and lower bars 10, 12 of the shading device 9. The motorized drive device 17 and, more particularly, the first and second electromechanical actuators 18, 20, may be configured to rotate two winding shafts. The winding shafts comprise an upper winding shaft and a lower winding shaft. The upper winding shaft is dedicated to moving the upper bar 10 and the lower winding shaft is dedicated to moving the lower bar 12. The two electromechanical actuators may be distinct or share common parts, for example the control unit and/or an electric motor. However, such a structure is not restrictive and it is also possible for the solar protection installation I to comprise a single electromechanical actuator 18, 20 comprising two coaxial shafts, or two parallel winding shafts.

The control unit 30 is configured to control the displacement of the upper bar 10 depending on an active state or an inactive state of a switching element 310, 330 that the remote control unit T comprises, and to control the displacement of the upper bar 12 depending on the active state or the inactive state of another of the switching elements 310, 330 which the remote control unit T comprises.

Finally, the solar protection installation I comprises this remote control unit T which comprises at least two actuating devices 101, 103 disposed substantially parallel to each other.

The provisions described above make it possible to propose a solar protection installation I in which the control of the actuation of the two bars 10, 12 is made intuitive by the positioning of the two actuating devices 101, 103 on the remote control unit T which is representative of the parallel spatial distribution of the two bars 10, 12.

As indicated above, a first object of the invention relates more particularly to the remote control unit T, an embodiment of which is represented in FIG. 2 and now described below.

The remote control unit T firstly comprises a housing 200 extending for example along the longitudinal axis X, and at least two actuating devices 101, 103. In the remainder of the description, reference may be made to two actuating devices 101, 103, but it is clearly understood that the remote control unit T may comprise more than two actuating devices 101, 103 which are of the same type or of types different from said two actuating devices 101, 103.

FIG. 2 illustrates an example of a remote control unit T comprising a first actuating device 101 and a second actuating device 103. The actuating device 101 has an elongated shape along an elongation direction Y1. The actuating device 103 has an elongated shape along an elongation direction Y2. These two actuating devices 101, 103 are disposed substantially parallel to each other. For example, the first actuating device 101 extends along a first elongation direction Y1, and the second actuating device 103 extends along a second elongation direction Y2, said first elongation direction Y1 being parallel to the second elongation direction Y2. Said at least two actuating devices 101, 103 are further offset from one another along the longitudinal axis X, the latter extending substantially perpendicular to the first elongation direction Y1 and to the second elongation direction Y2.

For example, the first actuating device 101 is configured to control the displacement of the upper bar 10 of the solar protection installation I, and the second actuating device 103 is configured to control the displacement of the lower bar 12 of the solar protection installation I.

Each actuating device 101, 103 is mounted so as to tilt relative to the housing 200 about a tilt axis A. Generally speaking, the elongation direction Y1, Y2 is substantially parallel to at least one of the tilt axes A. By “tilting” is meant a possibility of movement including at least one degree of rotation and possibly at least one degree of translation.

The housing 200 may comprise a grip portion 201 and a control portion 203 distinct from each other, in particular offset from each other in a direction in which the thickness of the housing 200 is measured so as to constitute respectively all or part of a rear face of the housing 200 and all or part of a front face of the housing 200. The actuating devices 101, 103 may be mounted so as to tilt relative to the housing 200 in the control portion 203. Thus, the user of the remote control unit T can hold the remote control unit T in his hand at the grip portion 201 while simply actuating the actuating device 101, 103, for example with his thumb at the control portion 203.

The remote control unit T also comprises at least one electronic control circuit 300 housed in the housing 200, and comprising at least two switching elements 310, 330 each likely to selectively occupy an active state and an inactive state. As indicated above, the active state and the inactive state of each of the switching elements 310, 330 makes it possible to cause or not the movement of the upper bar 10 of the solar protection installation I through the first electromechanical actuator 18, and to cause or not the movement of the lower bar 12 of the solar protection installation I through the second electromechanical actuator 20.

The control circuit 300 may comprise a radio transmitter, configured to transmit, to the control unit 30 of the shading device 9, commands for moving the bars 10, 12. The control circuit 300 also comprises a microprocessor and hardware and software means for interpreting an activation of one or several switching elements into a corresponding command to the shading device 9. The control unit 30 of the shading device also comprises hardware and software means for, upon receipt of a command from the remote control unit T, interpreting this command and consequently activating the displacement of the upper bar 10, of the lower bar 12 or of the two bars simultaneously, through at least one electromechanical actuator.

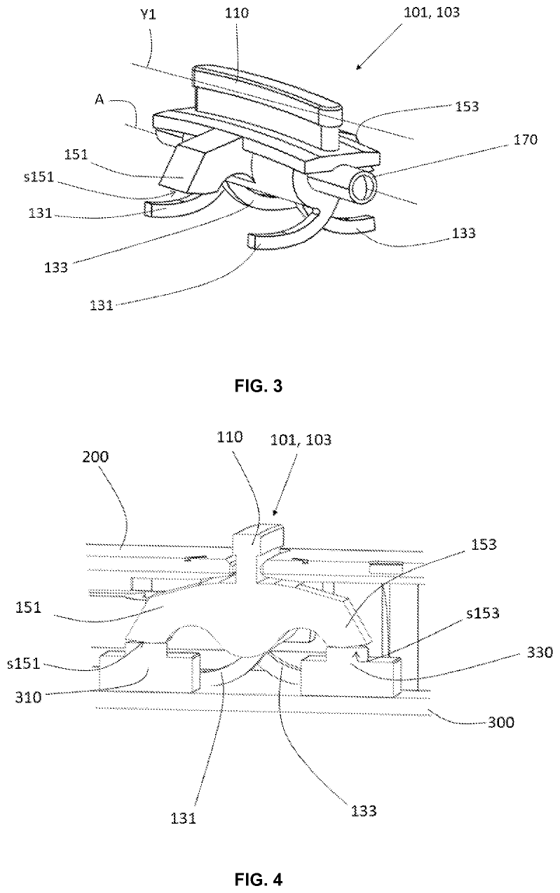

FIGS. 3 to 6 more particularly illustrate an embodiment of an actuating device 101, 103. Although FIGS. 3 to 6 only illustrate a single actuating device 10, 103, it is understood that all of the actuating devices 101, 103 may have a structure similar to that represented.

Each actuating device 101, 103 comprises a control button 110 configured to tilt about the at least one tilt axis A between a rest position and at least one actuating position. More specifically, the at least one of the actuating devices 101, 103 is pivotally mounted relative to the housing 200, about the tilt axis A. By “pivoting” is meant a possibility of movement including only one degree of rotation. This makes it possible to perform the actuation of the switching element 310, 330 with a simple movement about the tilt axis A, without necessarily requiring a complex kinematic of the tilting of the control button 110 to be proposed. Generally speaking, the tilt axes A of the control buttons 110 are substantially parallel. Furthermore, the control buttons 110 may have an elongated shape which extends along the elongation direction Y1, Y2. Furthermore, the elongated shape of the control buttons 110 can extend substantially parallel to the tilt axis A. Thus, the actuation of the control button 110 by a user's finger is facilitated. Indeed, the shape of the control button 110 allows the displacement of the control button 110 transversely to its elongation.

The actuating device 101, 103 may comprise a guide element 170, which may be in the form of a slider, for example, secured to the control button 110 and configured to allow the control button 110 to tilt about the at least one tilt axis A. For example, the guide element 170 extends along an axis parallel to or coincident with the tilt axis A. The housing 200 may comprise a recess configured to receive at least one projecting portion of the guide element 170, so as to allow, directly or indirectly, the actuating device 101, 103 to be mounted so as to tilt relative to the housing 200. According to one embodiment, the guide element 170 is configured to pivot about the tilt axis A when the control button 110 is tilted between the at least one actuating position and the position rest. In this way, it is possible to make the connection between the actuating device 101, 103 and the housing 200 robust.

The actuating device 101, 103 also comprises at least one return element 131, 133 tending to tilt the control button 110 about the at least one tilt axis A towards the rest position. For example, as illustrated in FIGS. 3 to 6, at least one of the return elements 131, 133 is an elastic return blade. Thus, the manufacture of the at least one return element 131, 133 is simple. This elastic return blade may comprise at least one curved portion.

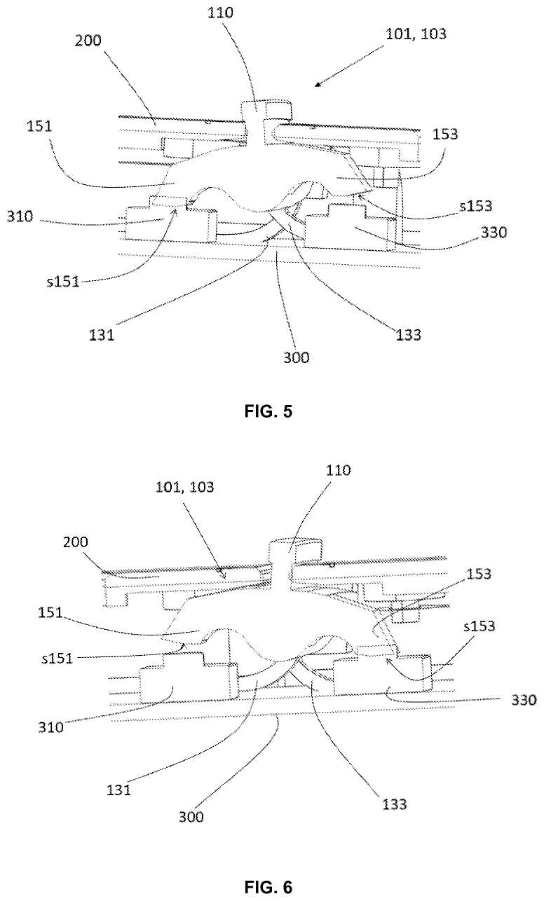

Referring to FIGS. 3 to 6, the at least one actuating position comprises a first actuating position and a second actuating position, distinct from each other. FIG. 4 illustrates the actuating device 101, 103 in the rest position, while FIG. 5 illustrates the actuating device 101, 103 in the first actuating position and FIG. 6 illustrates the actuating device 101, 103 in the second actuating position.

In this way, it is possible to obtain an actuating device 101, 103 in which the control button 110 is able to vary between two actuating positions, for example to actuate two distinct switching elements 310, 330. More particularly, the direction of tilting of the control button 110 about the at least one tilt axis A from the first actuating position to the rest position is opposite to the direction of tilting of the control button 110 about the at least one tilt axis A from the second actuating position to the rest position. In this way, the control button 110 is able to actuate one or several switching elements 310, 330 in a back-and-forth movement, which makes the actuating device 101, 103 ergonomic and user-friendly.

Even though it is possible to provide only one return element operating bidirectionally, it is preferred that the at least one return element 131, 133 comprises a first return element 131 tending to tilt the control button 110 about the at least one tilt axis A towards the rest position when the control button 110 is tilted towards the first actuating position and a second return element 133 tending to tilt the control button 110 about the at least one tilt axis A towards the rest position when the control button 110 is tilted towards the second actuating position. In other words:
when an actuating device has been manually actuated in a first direction sT1 between the rest position and the first actuating position, the first return element 131 exerts on the control button 110 a first return torque urging the control button 110 to pivot about the at least one tilt axis A in a reverse tilt direction going from the first actuating position to the rest position,
when an actuating device has been manually actuated in a second direction sT2 between the rest position and the second actuating position, the second return element 133 exerts on the control button 110 a second return torque urging the control button 110 to pivot about the at least one tilt axis A in a reverse tilt direction going from the second actuating position to the rest position.

FIG. 3 further illustrates one variant in which each of the first return element 131 and the second return element 133 comprises two elastic return blades offset from each other along the tilt axis A. These two elastic return blades of the first return element 131 are further opposite the two elastic return blades of the second return element 133 relative to the guide element 170, allowing good symmetrical balancing.

Finally, the actuating device 101, 103 comprises at least one actuating member 151, 153 secured to tilt with the control button 110. The at least one actuating member 151, 153 cooperates with one of the switching elements 310, 330 of the electronic control circuit 300 and is configured to actuate this switching element 310, 330 to place it in the active state or in the inactive state. In other words, the at least one actuating member 151, 153 ensures the transition of the switching element 310, 330 with which it cooperates from the active state to the inactive state and/or the transition from the inactive state to the active state. For example, the at least one of the actuating members 151, 153 is configured to place the switching element 310, 330 with which it cooperates in the active state when the control button 110 is tilted into the actuating position.

On the other hand, the at least one of the actuating members 151, 153 is configured to place the switching element 310, 330 with which it cooperates in the inactive state when the control button 110 is tilted into the rest position.

As illustrated in FIGS. 3 to 6, the actuating members 151, 153 may comprise a pressing stud projecting relative to the control button 110. For example, the pressing stud of the actuating member 151, 153 projects from the guide element 170. The pressing stud advantageously has a pressing surface s151, s153 configured to come into pressing contact, at least in the actuating position of the control button 110, with the switching element 310, 330. This makes it possible to form an actuating member 151, 153 that is sufficiently precise and robust to actuate the switching element 310, 330.

In the non-limiting variants presented in FIGS. 3 to 6, the at least one switching element 310, 330 of the electronic control circuit 300 comprises a first switching element 310 and a second switching element 330. Furthermore, the at least one actuating member 151, 153 of the actuating device 101, 103 comprises a first actuating member 151 configured to actuate the first switching element 310 when the control button 110 is tilted into the first actuating position, and a second actuating member 153 configured to actuate the second switching element 330 when the control button 110 is tilted into the second actuating position. According to a non-limiting variant, the second actuating member 153 is disposed on the side opposite the first actuating member 151 relative to the control button 110, or relative to the guide element 170. In this way, an actuating device 101, 103 of the remote control unit T is capable of controlling, on its own, two different actions through a single control button 110. In addition, the actuating device 101, 103 is thus able to actuate two distinct switching elements 310, 330 when the control button 110 is tilted into the different actuating positions. In the case of using the remote control unit T to control a shading device 9 of a solar protection installation I, a single actuating device 101, 103 can actuate one of the bars 10, 12 of the shading device 9 in a first direction of displacement sB1 and in a second direction of displacement sB2. In particular, the actuation in the first direction sT1 of the control button 110 of the first actuating device 101 makes it possible to control a movement of the upper bar 10 in a first direction of displacement sB1 and the actuation in the second direction sT2 of the control button 110 of the first actuating device 101 makes it possible to control a movement of the upper bar 10 in a second direction of displacement sB2. Similarly, the actuation in the first direction sT1 of the control button 110 of the second actuating device 103 makes it possible to control a movement of the lower bar 12 in a first direction of displacement sB1 and the actuation in the second direction sT2 of the control button 110 of the second actuating device 103 makes it possible to control a movement of the lower bar 12 in a second direction of displacement sB2.

Finally, as can be seen in the figures, it may be provided that the return element 131, 133 is integrally formed with the control button 110. In other words, the at least one return element 131, 133 and the control button 110 are integrally formed in a single and same part. In the same way, it may be provided that the actuating member 151, 153 is integrally formed with the control button 110, and more generally, that the actuating device 101, 103 is a single integral part. For example, the actuating device 101, 103 comprises or is made of a polymer material, such as polyoxymethylene.

The production of an actuating device 101, 103 in which the control button 110 and/or the actuating member 151, 153 is integrally formed with the return element 131, 133 has many advantages. This makes it possible in particular to:
make the manufacture of the actuating device 101, 103 simple, which limits the production costs of such an actuating device 101, 103;
produce the actuating device 101, 103 without requiring a fitted mechanical assembly between the return element 131, 133 and the control button 110, the obtained actuating device 101, 103 is thus robust, efficient and economical; and
limit the number of parts to be used when assembling the actuating device 101, 103.

Furthermore, the use of a polymer material makes it possible to produce the actuating device 101, 103 with low-cost manufacturing methods. Polyoxymethylene is particularly suitable as a material forming the return element 131, 133 to withstand friction, in particular induced during the displacement of the actuating device 101, 103.

According to a non-limiting variant represented in FIG. 2, it is possible for the remote control unit T to further comprise an independent button 105, activating an additional switching element (not represented). In this case, the control unit 30 can be configured to control the simultaneous displacement of the lower bar 12 and the upper bar 10 in the same direction of displacement when the additional switching element is activated by the independent button 105. For example, such simultaneous displacement of the lower bar 12 and the upper bar 10 is performed for a predetermined period. For example, the independent button 105 is kept illuminated when it activates the additional switching element, and in particular during said predetermined period.

The provisions described above make it possible to propose a remote control unit T capable of controlling an installation controlled by a control unit, for example a solar protection installation I comprising a control unit 30. The presence of two actuating devices 101, 103 makes it possible to increase the number of commands that can be transmitted by the remote control unit T when a user actuates one of the two actuating devices 101, 103. Furthermore, and advantageously, if the remote control unit T is configured to control a solar protection installation I comprising two bars 10, 12 that can be moved independently or jointly, the positioning of the two actuating devices 101, 103 on the remote control unit T can correspond to the spatial distribution of the two bars 10, 12. In this way, the control of displacement of the two bars 10, 12 is intuitive and the solution is user-friendly, simple and economical. The provisions described above also make it possible to propose a remote control unit T in which each actuating device 101, 103 is adapted to actuate a switching element 310, 330 when the control button 110 is actuated by the user and to return to the rest position when the control button 110 is not actuated.

1. A remote control unit intended to control a control unit of a solar protection installation, said remote control unit comprising:
a housing;
at least one electronic control circuit housed in the housing, and comprising at least two switching elements each likely to occupy an active state and an inactive state;
at least two actuating devices where each actuating device is mounted so as to tilt relative to the housing and comprises:
a control button configured to tilt about at least one tilt axis between a rest position and at least one actuating position;
at least one return element tending to tilt the control button about said at least one tilt axis towards the rest position;
at least one actuating member secured to tilt with the control button, said at least one actuating member cooperating with one of the switching elements of the at least one electronic control circuit, and being configured to actuate said one of the switching elements to place it in the active state or in the inactive state;
remote control unit in which, for at least one of the actuating devices, the at least one actuating position comprises a first actuating position and a distinct second actuating position;
wherein the at least one switching element of the electronic control circuit comprises a first switching element and a second switching element, and wherein the at least one actuating member, of one of the actuating devices comprises a first actuating member configured to actuate the first switching element when the control button occupies the first actuating positin, and a second actuating member configured to actuate the second switching element when the control button occupies the second actuating position; and
wherein said at least two actuating devices each have an elongated shape along an elongation direction, and are disposed substantially parallel to each other, said at least two actuating devices being further offset from each other along a longitudinal axis extending substantially perpendicular to the elongation direction.

2. The remote control unit according to claim 1, wherein the housing comprises a grip portion and a control portion distinct from each other, said actuating devices being mounted so as to tilt relative to the housing in the control portion.

3. The remote control unit according to claim 1 wherein the at least one of said actuating devices is pivotally mounted relative to the housing about the tilt axis.

4. The remote control unit according to claim 1 wherein said at least one return element is integrally formed with the control button.

5. The remote control unit according to claim 1, wherein a direction of tilting of the control button about the at least one tilt axis from the first actuating position to the rest position is opposite to a direction of tilting of the control button about the at least one tilt axis from the second actuating position to the rest position.

6. The remote control unit according to claim 5, wherein the at least one return element comprises a first return element tending, when an actuating device has been manually actuated in a first direction between the rest position and the first actuating position, to tilt the control button about the at least one tilt axis from the first actuating position to the rest position in the reverse tilt direction, and a second return element tending, when an actuating device has been manually actuated in a second direction between the rest position and the second actuating position, to tilt the control button about the at least one tilt axis from the second actuating position to the rest position in the reverse tilt direction.

7. The remote control unit according to claim 1 wherein at least one of the return elements is an elastic return blade.

8. The remote control unit according to claim 7, wherein said elastic return blade comprises at least one curved portion.

9. The remote control unit according to claim 1 wherein the elongated shape of at least one of the control buttons extends substantially parallel to the tilt axis.

10. The remote control unit according to claim 1 wherein the at least one of the actuating members comprises a pressing stud projecting relative to the control button, said pressing stud having a pressing surface (s151, s153) configured to come into pressing contact, at least in the actuating position of the control button, with the switching element.

11. The remote control unit according to claim 1 wherein the at least one of the actuating devices comprises a guide element secured to the control button and configured to allow the control button to tilt about the at least one tilt axis.

12. The remote control unit according to claim 11, wherein the housing comprises a recess configured to receive at least one projecting portion of the guide element, so as to allow, directly or indirectly, the actuating device to be mounted so as to tilt relative to the housing.

13. A solar protection installation comprising:
a remote control unit according to claim 1 comprising a first and a second actuating device;
a shading device comprising at least:
an upper bar;
a lower bar; and
a screen disposed between the upper bar and the lower bar;
a motorized drive device configured to deploy and retract the screen, and comprising at least one electromechanical actuator configured to move the upper bar and the lower bar, the motorized drive device further comprising a control unit configured to control the displacement of the upper bar depending on the active or inactive state of the at least one of the switching elements associated with the first actuating device, and configured to control the displacement of the lower bar depending on the active or inactive state of the at least one of the switching elements associated with the second actuating device.
